(19) United States
(12) Patent Application Publication
(10) Pub. No.: US 2025/0183438 A1
(43) Pub. Date: Jun. 5, 2025

(54) BATTERY ENCLOSURE FOR ELECTRIC VEHICLES

(71) Applicant: Rivian IP Holdings, LLC, Irvine, CA (US)

(72) Inventors: Adam Richard BALLARD, Corona, CA (US); Sharbel ELKANTATI, Windsor (CA); Piyush KHATER, Mission Viejo, CA (US)

(21) Appl. No.: 18/528,584

(22) Filed: Dec. 4, 2023

(51) Int. Cl. H01M 50/233; H01M 50/224; H01M 50/262; H01M 50/271

(52) U.S. Cl. CPC H01M 50/233; H01M 50/224; H01M 50/262; H01M 50/271

(57) ABSTRACT

A battery enclosure and a battery enclosure tub are provided. The battery enclosure tub includes a flange, a wall, and a bottom that is configured to support a battery pack. The flange includes an outer edge, an inner rim defining an opening, and crack mitigation regions formed between the outer edge and the inner rim. The wall extends from the inner rim of the flange, and includes a first portion and a second portion. The first portion is joined to the inner rim of the flange, and the bottom is joined to the second portion of the wall.

### INTRODUCTION

The present disclosure relates to electric vehicles (EVs). More particularly, the present disclosure relates to battery enclosures for electric vehicles.

### SUMMARY

Embodiments of the present disclosure advantageously provide a battery enclosure and a battery enclosure tub for an electric vehicle.

In certain embodiments, the battery enclosure tub (apparatus) includes a flange, a wall, and a bottom that is configured to support a battery pack. The flange includes an outer edge, an inner rim defining an opening, and crack mitigation regions formed between the outer edge and the inner rim. The wall extends from the inner rim of the flange, and includes a first portion and a second portion. The first portion is joined to the inner rim of the flange, and the bottom is joined to the second portion of the wall.

### BRIEF DESCRIPTION OF THE DRAWINGS

FIG. 1 depicts a diagram of an example electric vehicle, in accordance with embodiments of the present disclosure.

FIG. 2 presents a top view of an example battery enclosure, in accordance with embodiments of the present disclosure.

FIG. 3 presents a top view of a portion of the right side of an example battery enclosure tub illustrating crack propagation-related issues associated with a side pole impact, in accordance with embodiments of the present disclosure.

FIGS. 4A, 4B present a top view and a cross sectional view, respectively, of a portion of the right side of an example battery enclosure tub, in accordance with embodiments of the present disclosure.

FIGS. 5A, 5B present a top view and a cross sectional view, respectively, of a portion of the right side of an example battery enclosure tub, in accordance with embodiments of the present disclosure.

FIGS. 6A, 6B present a top view and a cross sectional view, respectively, of a portion of the right side of an example battery enclosure tub, in accordance with embodiments of the present disclosure.

FIGS. 7A, 7B present a top view and a cross sectional view, respectively, of a portion of the right side of an example battery enclosure tub, in accordance with embodiments of the present disclosure.

FIGS. 8A, 8B present a top view and a cross sectional view, respectively, of a portion of the right side of an example battery enclosure tub, in accordance with embodiments of the present disclosure.

FIGS. 9A, 9B present a top view and a cross sectional view, respectively, of a portion of the right side of an example battery enclosure tub, in accordance with embodiments of the present disclosure.

FIGS. 10A, 10B present a top view and a cross sectional view, respectively, of a portion of the right side of an example battery enclosure tub, in accordance with embodiments of the present disclosure.

FIGS. 11A, 11B present a top view and a cross sectional view, respectively, of a portion of the right side of an example battery enclosure tub, in accordance with embodiments of the present disclosure.

FIGS. 12A, 12B, 12C present a top view, a bottom view, and a perspective view, respectively, of an example battery enclosure tub, in accordance with embodiments of the present disclosure.

FIGS. 12D, 12E present a top view and a bottom view, respectively, of a portion of the right side of the example battery enclosure tub depicted in FIGS. 12A, 12B, 12C, in accordance with embodiments of the present disclosure.

FIG. 13 presents a perspective view of another example battery enclosure tub, in accordance with embodiments of the present disclosure.

FIG. 14A presents a perspective view of an example composite cover, in accordance with embodiments of the present disclosure.

FIG. 14B presents a perspective view of a portion of a battery enclosure tub, a plate, and the example composite cover, in accordance with embodiments of the present disclosure.

### DETAILED DESCRIPTION

Embodiments of the present disclosure advantageously provide a battery enclosure and a battery enclosure tub (or tray) for an electric vehicle. The battery enclosure generally includes a battery enclosure tub and a battery enclosure cover. The battery enclosure tub supports the battery pack, and forms the lower portion of the battery enclosure. The battery enclosure cover forms the upper portion of the battery enclosure, which is attached and sealed to the battery enclosure tub to protect the battery pack from accidents, the elements, etc.

Battery enclosures for electric vehicles have strict structural and sealing requirements. The structural requirements may include, inter alia, satisfactorily reacting to an impact load, such as a side pole impact (i.e., a perpendicular impact to the side of the vehicle), an underside impact, a frontal offset impact, etc. The sealing requirements may include, inter alia, protection against water ingress, remaining sealed through 5 minutes of thermal runaway, etc. For example, Underwriters Laboratory (UL) has developed several electric vehicle battery standards, such as UL2580 (the Standard for Batteries for Use in Electric Vehicles), UL2271 (the Standard for Batteries for Use in Light Electric Vehicle (LEV) Applications), etc.

Generally, the battery enclosure should be exceptionally strong, heat-resistant, and pressure-resistant while remaining relatively lightweight. Electric vehicle manufacturers typically use lightweight, low strength metallic panels or sheets for many components, including battery enclosures. Unfortunately, battery enclosure tubs formed from low strength metallic sheets (such as low strength steel or low strength aluminum) are vulnerable to spot weld cracks that cause failures during leak testing.

Additionally, battery enclosure tubs formed from low strength steel or aluminum sheets are vulnerable to cracking caused by impact loads, such as side pole impact loads. The cracks originate on the outside edge of the mounting flange of the battery enclosure tub, and then propagate across the flange, through a region of sealing material, and inward towards the wall of the battery enclosure tub. Once a crack propagates across the sealing material on the flange, the integrity of the sealed battery enclosure may be compromised.

For example, the battery enclosure may be designed to vent noxious gasses away from the passengers in the cabin during a battery pack malfunction, such as during an electrical fire, a thermal runaway, an accident, etc. Cracks that compromise the integrity of the battery enclosure may vent these noxious gasses towards the passengers, which is not desirable.

Embodiments of the present disclosure advantageously provide structural and material features that stop, mitigate, or redirect cracks that would otherwise propagate from the outer edge of the flange of the battery enclosure tub, across the sealing material, and into the sealed compartment of the battery enclosure.

Embodiments of the present disclosure provide a battery enclosure tub that includes a flange, a wall, and a bottom that is configured to support a battery pack. The flange includes an outer edge, an inner rim defining an opening, and crack mitigation regions formed between the outer edge and the inner rim. The wall extends from the inner rim of the flange, and includes a first portion and a second portion. The first portion is joined to the inner rim of the flange, and the bottom is joined to the second portion of the wall.

In certain embodiments, the flange, the wall, and the bottom may be formed from a metal sheet by a stamping process, such as a hot stamping process or a cold stamping process. The metal sheet itself may be formed by laser welding different types of metal sheets together. The metal sheets may have different thicknesses, different material properties (such as ductility, etc.), etc. For example, the tailor welding process produces a tailor welded blank or a tailor welded coil from different metal sheets. Advantageously, the crack mitigation regions may be thicker than other sections of the battery enclosure tub, such as the bottom and portions of the wall.

In certain embodiments, the crack mitigation region may include various structures, such as raised or lowered beads, openings, soft zones, ductility variations, etc.

In certain embodiments, a bottom plate may be attached to the bottom, and a composite molded side cover may be attached to each side of the bottom plate (and each side of the flange). The composite molded side covers form respective box sections that absorb at least a portion of the load during side pole impacts, and also create torsional stability for the overall battery enclosure.

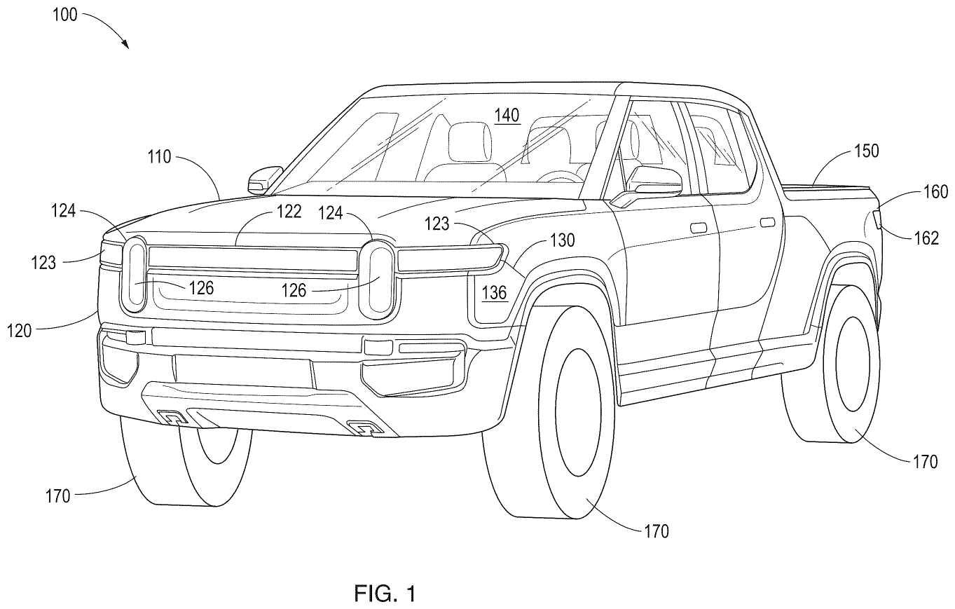

FIG. 1 depicts a diagram of electric vehicle 100, in accordance with embodiments of the present disclosure.

Electric vehicle 100 includes, inter alia, a frame and body 110, an electrical power storage and distribution system, a propulsion system, a suspension system, a steering system, auxiliary and accessory systems (such as thermal management, lighting, wireless communications, navigation, etc.), etc.

Generally, body 110 may be directly or indirectly mounted to a frame (i.e., body-on-frame construction), or body 110 may be formed integrally with a frame (i.e., unibody construction). Body 110 includes, inter alia, front end 120, front light bar 122, front turn lights 123, stadium light ring 124, headlights 126, charging port 130 with charging port cover 136 concealing charging connector socket, driver/passenger compartment or cabin 140, bed 150, rear end 160 with rear tail lights 162, a rear light bar, etc. Electric vehicle 100 may be a pickup truck, a sport utility vehicle (SUV) in which bed 150 is replaced by an extension of cabin 140, or a sedan in which bed 150 is replaced by a trunk. In certain embodiments, electric vehicle may be an electric delivery vehicle, an electric cargo van, etc.

The propulsion system may include, inter alia, one or more electronic control units (ECUs), one or more electronic drive units (EDUs), wheels 170, etc. The electrical power storage and distribution system may include, inter alia, one or more ECUs, a battery enclosure containing a battery pack including one or more battery modules, a vehicle charging subsystem including charging port 130, high voltage (HV) cables, etc.

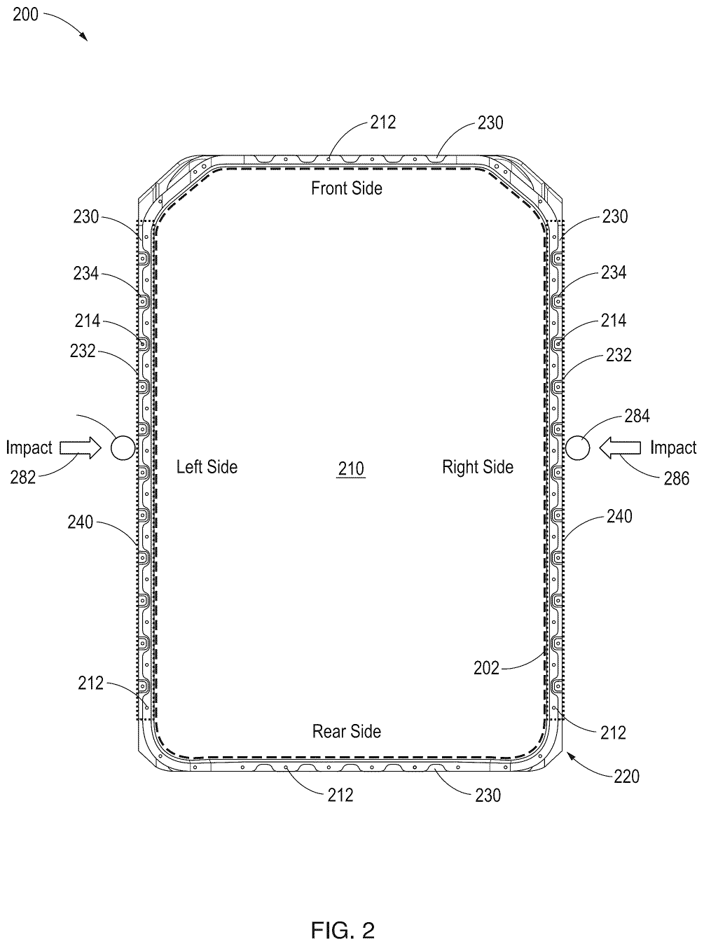

FIG. 2 presents a top view of battery enclosure 200, in accordance with embodiments of the present disclosure.

Battery enclosure 200 includes battery enclosure cover 210 attached to battery enclosure tub 220 using fasteners 212, such as screws, bolts and nuts, rivets, snap-fit clips, pins, etc. Battery enclosure 200 has a generally rectangular shape, with a front side, a left side, a right side, and a rear side.

Sealing material 202 may be disposed between battery enclosure cover and 210 battery enclosure tub 220 to provide a continuous seal along the periphery of battery enclosure 200. Sealing material 202 may protect against water intrusion, thermal runaway, etc., as noted above.

Similarly, battery enclosure tub 220 has a generally rectangular shape, with a front side, a left side, a right side, and a rear side. Battery enclosure tub 220 includes flange 230 that forms the periphery of the left side and the right side of battery enclosure 200. The flange 230 on the left side of battery enclosure tub 220 and the flange 230 on the right side of battery enclosure tub 220 may include outer edge 232 and a number of mounting pads 234. Battery enclosure 200 may be attached to electric vehicle 100 (such as the frame, etc.) using fasteners 214, such as screws, bolts and nuts, rivets, etc. Each mounting pad 234 may be configured to cooperate with one of the fasteners 214 to attach battery enclosure tub 220 to electric vehicle 100.

Two side load impact examples are depicted in FIG. 2. One side load impact to the left side of battery enclosure 200 is represented by side pole 280 and direction of impact arrow 282, while another side load impact to the right side of battery enclosure 200 is represented by side pole 284 and direction of impact arrow 286. Flange 230 on the left side of battery enclosure tub 220 and flange 230 on the right side of battery enclosure tub 220 are generally perpendicular to the direction of impact arrows 282, 286 (respectively) due to the orientation of battery enclosure 200 with respect to the frame of electric vehicle 100. In other words, the front, left, right and rear sides of battery enclosure 200 are generally aligned with the front, left, right and rear sides of electric vehicle 100.

Because the side load impact may occur anywhere along the left side or the right side of battery enclosure 200, flange 230 includes crack mitigation regions 240 that extend along both the left side and the right side of battery enclosure tub 220. Embodiments of the present disclosure advantageously provide structural and material features within crack mitigation regions 240 that stop, mitigate, or redirect cracks that would otherwise propagate from outer edge 232 of flange 230 into the sealed compartment of battery enclosure 200.

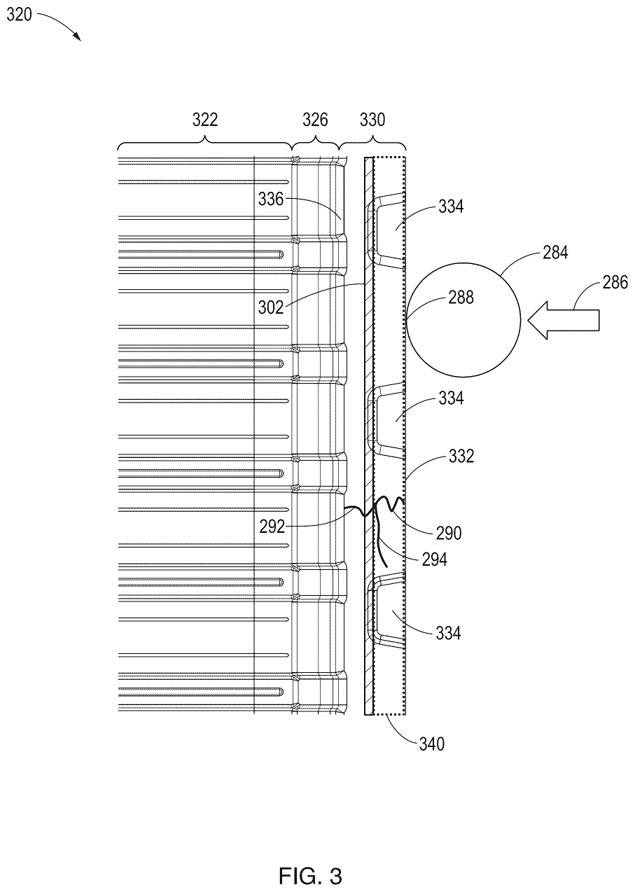

FIG. 3 presents a top view of a portion of the right side of battery enclosure tub 320 illustrating crack propagation-related issues associated with a side pole impact, in accordance with embodiments of the present disclosure.

Battery enclosure tub 320 includes, inter alia, flange 330, wall 326, and bottom 322. Flange 330 includes outer edge 332, mounting pads 334, inner rim 336, and crack mitigation region 340 formed between outer edge 332 and inner rim 336. Sealing material 302 may be disposed on the upper surface of flange 330 between inner rim 336 and crack mitigation region 340. Accordingly, crack mitigation region 340 may be advantageously formed between outer edge 332 and sealing material 302 to stop, mitigate, or redirect cracks that would otherwise propagate from outer edge 232 of flange 230 into the sealed compartment of battery enclosure 200. Wall 326 extends from inner rim 336, and includes an upper portion joined to inner rim 336, and a lower portion. Bottom 322 is joined to the lower portion of wall 326, and is configured to support a battery pack.

Generally, the components and features of battery enclosure tub 320, such as flange 330, wall 326, bottom 322, mounting pads 334, etc., may be formed from a metal sheet by a stamping process, such as a hot stamping process, a cold stamping process, etc. In certain embodiments, the stamping process is a one-step process (such as hot stamping), while in other embodiments, the stamping process may include two (or more) steps separated by time and possibly performed by different apparatus (such as cold stamping).

During a side impact, side pole 284 strikes outer edge 332 in direction of impact arrow 286, which may deform flange 330 at impact location 288 and cause tension in outer edge 332 proximate to impact location 288, leading to the formation of crack 290 that propagates from outer edge 332 inward toward sealing material 302.

Without crack mitigation region 340, crack 290 may continue to propagate inward, past sealing material 302, and towards inner rim 336 (as crack 292), thereby compromising the integrity of sealed battery enclosure 200. Accordingly, crack mitigation region 340 advantageously prevents the propagation of crack 290 past sealing material 302 (as crack 292) or redirects the propagation of crack 290 away from sealing material 302 (as crack 294).

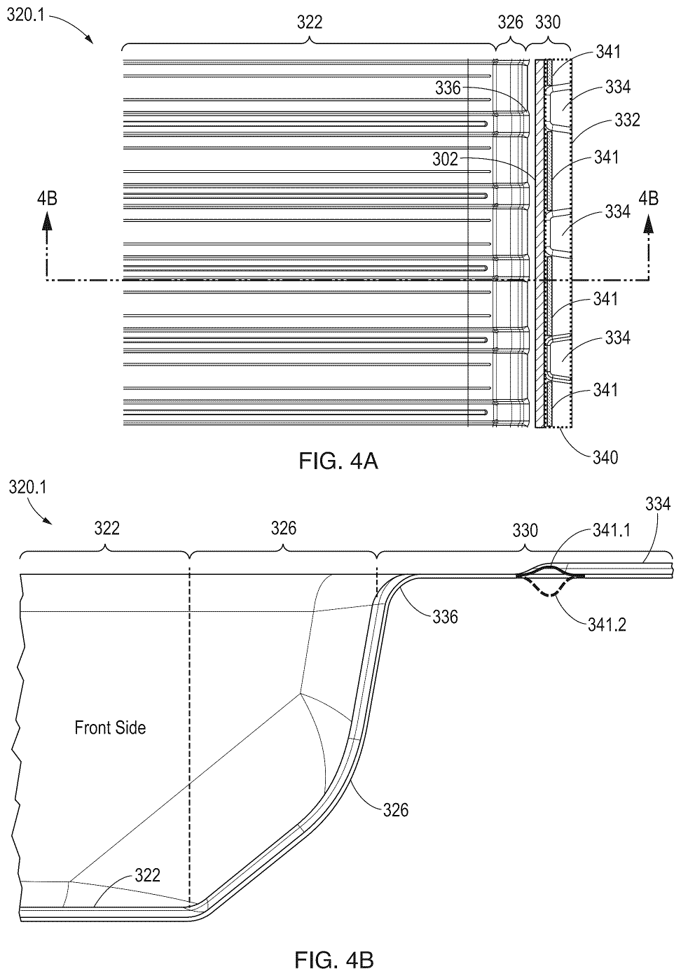

FIGS. 4A, 4B present a top view and a cross sectional view, respectively, of a portion of the right side of battery enclosure tub 320.1, in accordance with embodiments of the present disclosure.

Battery enclosure tub 320.1 includes, inter alia, flange 330, wall 326, and bottom 322 as described above with respect to battery enclosure tub 320. Flange 330 includes outer edge 332, mounting pads 334, inner rim 336, and crack mitigation region 340 formed between outer edge 332 and inner rim 336. Sealing material 302 may be disposed on the upper surface of flange 330 between inner rim 336 and crack mitigation region 340. Wall 326 extends from inner rim 336, and includes an upper portion joined to inner rim 336, and a lower portion. Bottom 322 is joined to the lower portion of wall 326, and is configured to support a battery pack.

Crack mitigation region 340 may include beads 341 that are formed between mounting pads 334 to stop, mitigate, or redirect cracks that would otherwise propagate from outer edge 332 of flange 330 into the sealed compartment of battery enclosure 200. In certain embodiments, at least one bead 341 may be formed between each pair of adjacent mounting pads 334, while in other embodiments, at least one bead 341 may be formed between certain pairs of mounting pads 334, such as every other pair of mounting pads 334, centrally-located pairs of mounting pads 334, etc. Beads 341 may be formed in crack mitigation region 340 during the stamping process described above.

Generally, each bead 341 may be formed in a straight line parallel to sealing material 302.

In certain embodiments, beads 341 include beads 341.1 that extend above the upper surface of flange 330. In other embodiments, beads 341 include beads 341.2 that extend below the lower surface of flange 330. In further embodiments, beads 341 include a combination of beads 341.1 and beads 341.2. Beads 341.1 may be stamped such that the height above the upper surface of flange 330 is less than or equal to 75% of the height of mounting pads 334. Similarly, beads 341.2 may be stamped such that the depth below the lower surface of flange 330 is equal to or less than the depth permitted by the formability of the stamping process. The width of each bead 341 may be the same (such as 25% of the width of mounting pads 334, 40% of the width of mounting pads 334, etc.), or, alternatively, the width may vary depending on the number of beads 341 that are disposed between each pair of mounting pads 334.

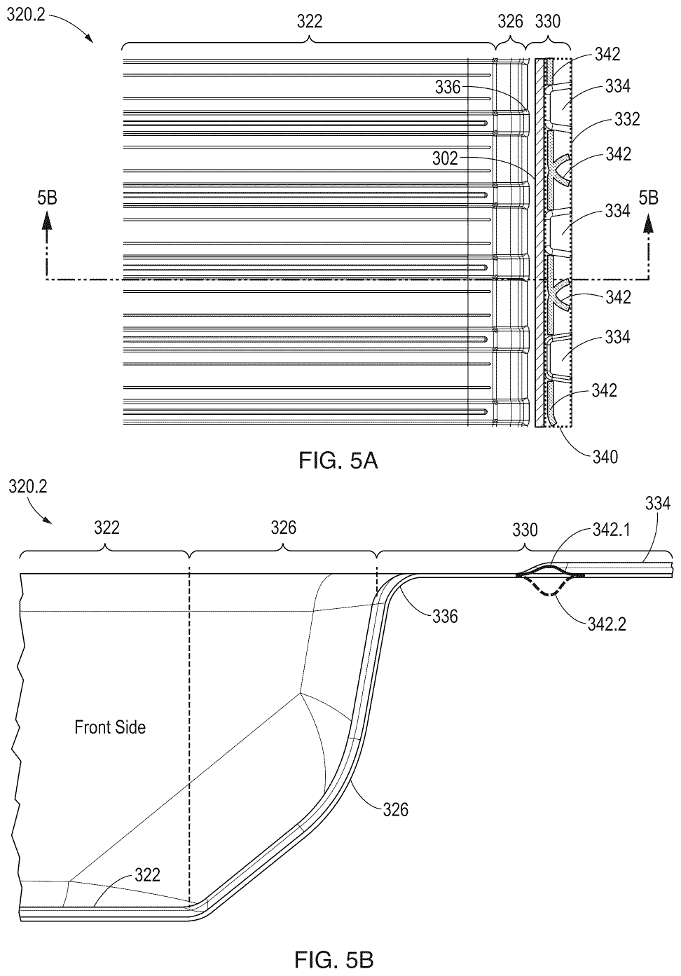

FIGS. 5A, 5B present a top view and a cross sectional view, respectively, of a portion of the right side of battery enclosure tub 320.2, in accordance with embodiments of the present disclosure.

Battery enclosure tub 320.2 includes, inter alia, flange 330, wall 326, and bottom 322 as described above with respect to battery enclosure tub 320. Flange 330 includes outer edge 332, mounting pads 334, inner rim 336, and crack mitigation region 340 formed between outer edge 332 and inner rim 336. Sealing material 302 may be disposed on the upper surface of flange 330 between inner rim 336 and crack mitigation region 340. Wall 326 extends from inner rim 336, and includes an upper portion joined to inner rim 336, and a lower portion. Bottom 322 is joined to the lower portion of wall 326, and is configured to support a battery pack.

Crack mitigation region 340 may include beads 342 that are formed between mounting pads 334 to stop, mitigate, or redirect cracks that would otherwise propagate from outer edge 332 of flange 330 into the sealed compartment of battery enclosure 200. In certain embodiments, at least two beads 342 may be formed between each pair of adjacent mounting pads 334, while in other embodiments, at least two beads 342 may be formed between certain pairs of mounting pads 334, such as every other pair of mounting pads 334, centrally-located pairs of mounting pads 334, etc. Beads 342 may be formed in crack mitigation region 340 during the stamping process described above.

Generally, each bead 342 may be formed in a curved shape that spans the width of crack mitigation region 340, such as from outer edge 332 to sealing material 302. For example, each bead 342 may begin adjacent to outer edge 332, proceed along a curved path towards sealing material 302, and then proceed parallel to sealing material 302 until a mounting pad 334 is reached. Beads 343 formed between a pair of mounting pads 334 may intersect (as depicted) or may not intersect, and other shapes (and shape combinations) are also supported.

In certain embodiments, beads 342 include beads 342.1 that extend above the upper surface of flange 330. In other embodiments, beads 342 include beads 342.2 that extend below the lower surface of flange 330. In further embodiments, beads 342 include a combination of beads 342.1 and beads 342.2. Beads 342.1 may be stamped such that the height above the upper surface of flange 330 is less than or equal to 75% of the height of mounting pads 334. Similarly, beads 342.2 may be stamped such that the depth below the lower surface of flange 330 is equal to or less than the depth permitted by the formability of the stamping process. The width of each bead 342 may be the same (such as 25% of the width of mounting pads 334, 40% of the width of mounting pads 334, etc.), or, alternatively, the width may vary depending on the number of beads 342 that are disposed between each pair of mounting pads 334.

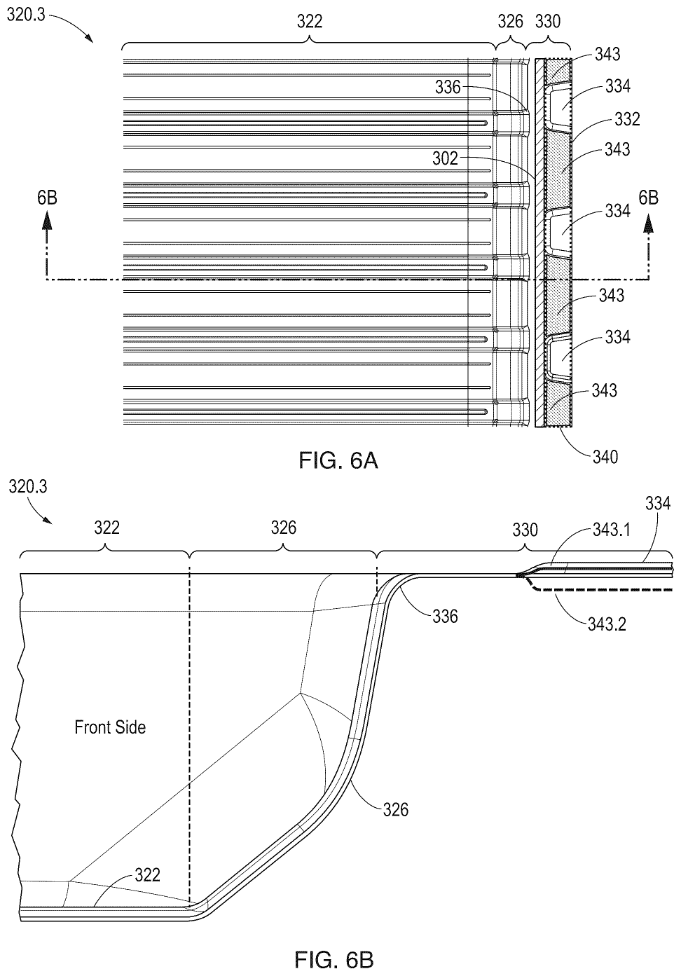

FIGS. 6A, 6B present a top view and a cross sectional view, respectively, of a portion of the right side of battery enclosure tub 320.3, in accordance with embodiments of the present disclosure.

Battery enclosure tub 320.3 includes, inter alia, flange 330, wall 326, and bottom 322 as described above with respect to battery enclosure tub 320. Flange 330 includes outer edge 332, mounting pads 334, inner rim 336, and crack mitigation region 340 formed between outer edge 332 and inner rim 336. Sealing material 302 may be disposed on the upper surface of flange 330 between inner rim 336 and crack mitigation region 340. Wall 326 extends from inner rim 336, and includes an upper portion joined to inner rim 336, and a lower portion. Bottom 322 is joined to the lower portion of wall 326, and is configured to support a battery pack.

Crack mitigation region 340 may include beads 343 that are formed between mounting pads 334 to stop, mitigate, or redirect cracks that would otherwise propagate from outer edge 332 of flange 330 into the sealed compartment of battery enclosure 200. In certain embodiments, one bead 343 may be formed between each pair of adjacent mounting pads 334, while in other embodiments, one bead 343 may be formed between certain pairs of mounting pads 334, such as every other pair of mounting pads 334, centrally-located pairs of mounting pads 334, etc. Beads 343 may be formed in crack mitigation region 340 during the stamping process described above.

Generally, each bead 343 may be formed in an extended rectangular or parallelogram shape to span the width of crack mitigation region 340 between a pair of adjacent mounting pads 334, such as from outer edge 332 to sealing material 302.

In certain embodiments, beads 343 include beads 343.1 that extend above the upper surface of flange 330. In other embodiments, beads 343 include beads 343.2 that extend below the lower surface of flange 330. In further embodiments, beads 343 include a combination of beads 343.1 and beads 343.2. Beads 342.1 may be stamped such that the height above the upper surface of flange 330 is less than or equal to 75% of the height of mounting pads 334. Similarly, beads 342.2 may be stamped such that the depth below the lower surface of flange 330 is equal to or less than the depth permitted by the formability of the stamping process.

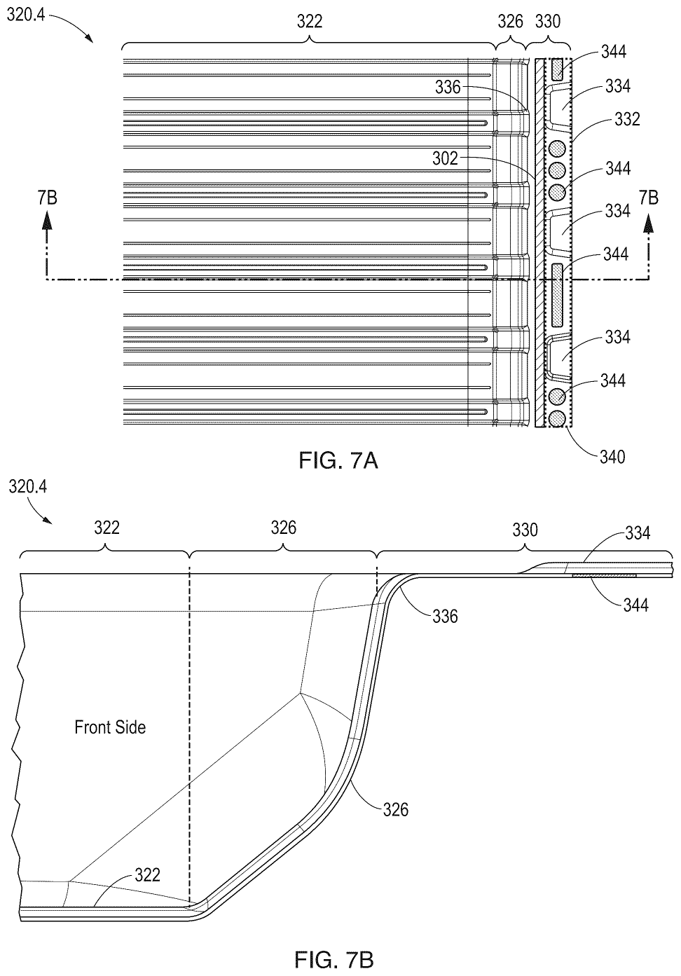

FIGS. 7A, 7B present a top view and a cross sectional view, respectively, of a portion of the right side of battery enclosure tub 320.4, in accordance with embodiments of the present disclosure.

Battery enclosure tub 320.4 includes, inter alia, flange 330, wall 326, and bottom 322 as described above with respect to battery enclosure tub 320. Flange 330 includes outer edge 332, mounting pads 334, inner rim 336, and crack mitigation region 340 formed between outer edge 332 and inner rim 336. Sealing material 302 may be disposed on the upper surface of flange 330 between inner rim 336 and crack mitigation region 340. Wall 326 extends from inner rim 336, and includes an upper portion joined to inner rim 336, and a lower portion. Bottom 322 is joined to the lower portion of wall 326, and is configured to support a battery pack.

Crack mitigation region 340 may include openings 344 that are formed between mounting pads 334 to stop, mitigate, or redirect cracks that would otherwise propagate from outer edge 332 of flange 330 into the sealed compartment of battery enclosure 200. In certain embodiments, at least one opening 344 may be formed between each pair of adjacent mounting pads 334, while in other embodiments, at least one opening 344 may be formed between certain pairs of mounting pads 334, such as every other pair of mounting pads 334, centrally-located pairs of mounting pads 334, etc. Openings 344 may be formed in crack mitigation region 340 during the stamping process described above.

Generally, each opening 344 may be formed in a rectangular shape, a circular shape, an oval shape, etc., and the opening(s) 334 between a pair of mounting pads 334 provide a total open area for that portion of crack mitigation region 340. In certain embodiments, the total open area between a pair of mounting pads 334 may be approximately 50% of the area of the crack mitigation region 340 between the pair of mounting pads 334. In other embodiments, the total open area may be less than 50% (such as 10%, 25%, 40%, etc.) of the area of the crack mitigation region 240 between the pair of mounting pads 334. While the total open area may also be more than 50% (such as 55%, 60%, etc.), a certain amount of material is needed to provide structural strength and integrity. The total open area may be the same (or different) for each pair of mounting pads 334.

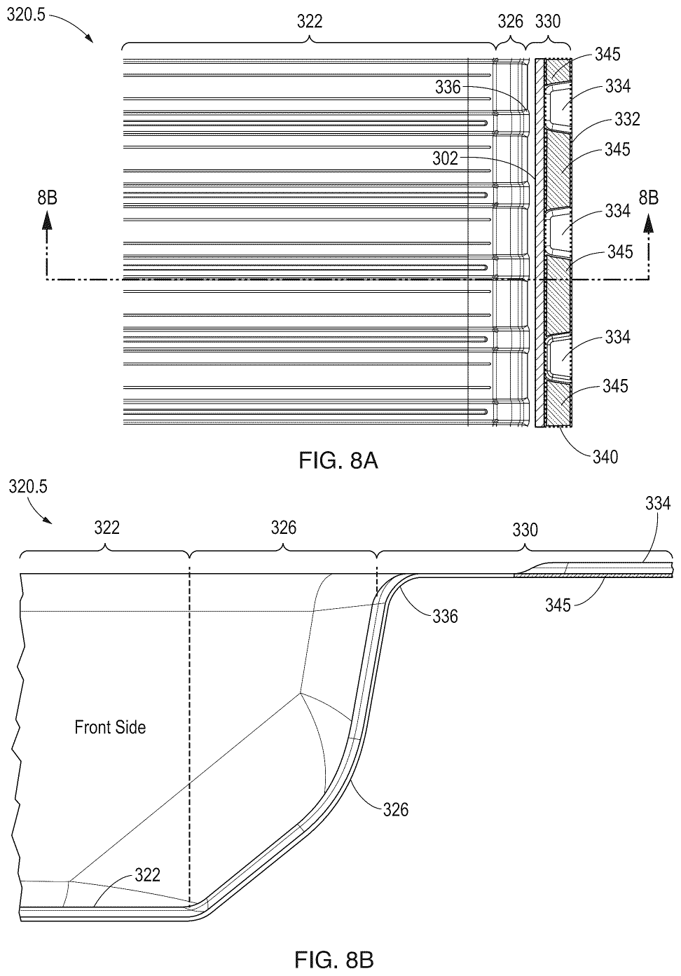

FIGS. 8A, 8B present a top view and a cross sectional view, respectively, of a portion of the right side of battery enclosure tub 320.5, in accordance with embodiments of the present disclosure.

Battery enclosure tub 320.5 includes, inter alia, flange 330, wall 326, and bottom 322 as described above with respect to battery enclosure tub 320. Flange 330 includes outer edge 332, mounting pads 334, inner rim 336, and crack mitigation region 340 formed between outer edge 332 and inner rim 336. Sealing material 302 may be disposed on the upper surface of flange 330 between inner rim 336 and crack mitigation region 340. Wall 326 extends from inner rim 336, and includes an upper portion joined to inner rim 336, and a lower portion. Bottom 322 is joined to the lower portion of wall 326, and is configured to support a battery pack.

Crack mitigation region 340 may include soft zones 345 that are formed between mounting pads 334 to stop, mitigate, or redirect cracks that would otherwise propagate from outer edge 332 of flange 330 into the sealed compartment of battery enclosure 200. In certain embodiments, one soft zone 345 may be formed between each pair of adjacent mounting pads 334, while in other embodiments, one soft zone 345 may be formed between certain pairs of mounting pads 334, such as every other pair of mounting pads 334, centrally-located pairs of mounting pads 334, etc.

Soft zones 345 may be formed in crack mitigation region 340 during the formation of the metal sheet, during the stamping process described above, etc. For example, during a hot stamping process, the areas of the metal sheet that will be stamped to form soft zones 345 may be heated to a higher temperature than the other areas of the metal sheet. Generally, soft zones 345 provide a less brittle and more ductile area within crack mitigation region 340 to allow for more local necking of the metal sheet before cracks are formed.

Each soft zone 345 may be formed in a rectangular or parallelogram shape to span the width of crack mitigation region 340 between a pair of adjacent mounting pads 334, such as from outer edge 332 to sealing material 302.

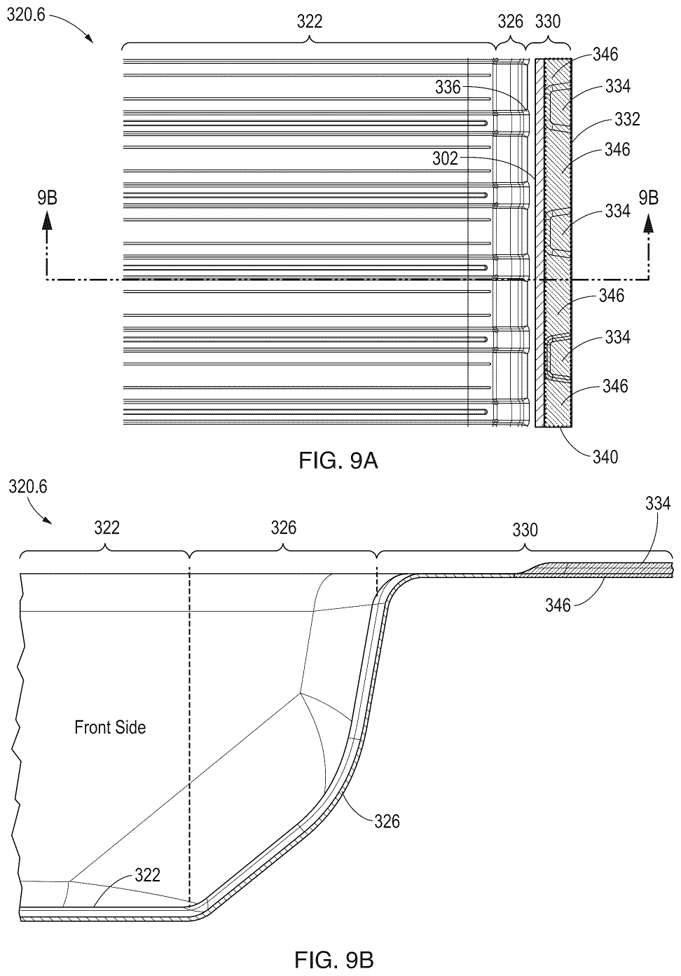

FIGS. 9A, 9B present a top view and a cross sectional view, respectively, of a portion of the right side of battery enclosure tub 320.6, in accordance with embodiments of the present disclosure.

Battery enclosure tub 320.6 includes, inter alia, flange 330, wall 326, and bottom 322 as described above with respect to battery enclosure tub 320. Flange 330 includes outer edge 332, mounting pads 334, inner rim 336, and crack mitigation region 340 formed between outer edge 332 and inner rim 336. Sealing material 302 may be disposed on the upper surface of flange 330 between inner rim 336 and crack mitigation region 340. Wall 326 extends from inner rim 336, and includes an upper portion joined to inner rim 336, and a lower portion. Bottom 322 is joined to the lower portion of wall 326, and is configured to support a battery pack.

Crack mitigation region 340 may include a single soft zone 346 (that includes mounting pads 334) to stop, mitigate, or redirect cracks that would otherwise propagate from outer edge 332 of flange 330 into the sealed compartment of battery enclosure 200.

Soft zone 346 may be formed in crack mitigation region 340 during the formation of the metal sheet, during the stamping process described above, etc. For example, during a hot stamping process, the areas of the metal sheet that will be stamped to form soft zone 346 may be heated to a higher temperature than the other areas of the metal sheet. Generally, soft zone 346 provides a less brittle and more ductile area within crack mitigation region 340 to allow for more local necking of the metal sheet before cracks are formed. For example, the metal sheet may be USIBOR 1500, which is a boron steel with an Al—Si coating that is specially suitable for hot stamping processes. Accordingly, in this example, soft zone 346 may be a USIBOR 1500 soft zone, while the remaining portion of flange 330, wall 326, and bottom 322 may be formed from full, high strength USIBOR 1500.

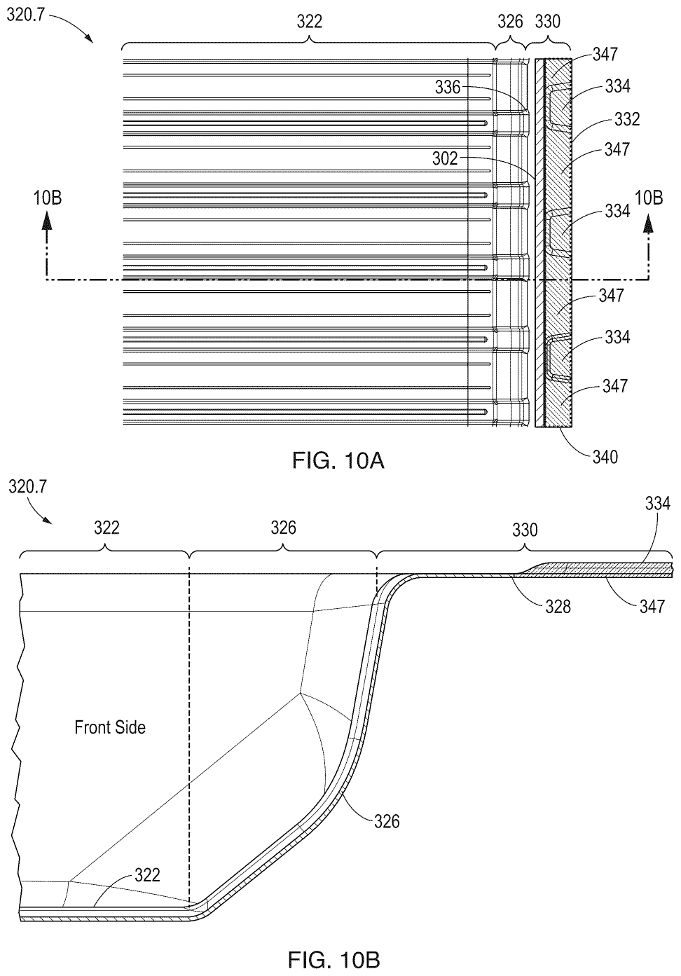

FIGS. 10A, 10B present a top view and a cross sectional view, respectively, of a portion of the right side of battery enclosure tub 320.7, in accordance with embodiments of the present disclosure.

Battery enclosure tub 320.7 includes, inter alia, flange 330, wall 326, and bottom 322 as described above with respect to battery enclosure tub 320. Flange 330 includes outer edge 332, mounting pads 334, inner rim 336, and crack mitigation region 340 formed between outer edge 332 and inner rim 336. Sealing material 302 may be disposed on the upper surface of flange 330 between inner rim 336 and crack mitigation region 340. Wall 326 extends from inner rim 336, and includes an upper portion joined to inner rim 336, and a lower portion. Bottom 322 is joined to the lower portion of wall 326, and is configured to support a battery pack.

Crack mitigation region 340 may include a single soft zone 347 (that includes mounting pads 334) to stop, mitigate, or redirect cracks that would otherwise propagate from outer edge 332 of flange 330 into the sealed compartment of battery enclosure 200.

Soft zone 347 may be formed in crack mitigation region 340 during the formation of the metal sheet. For example, the metal sheet may be a rectangular Tailor welded blank that has a central panel of USIBOR 1500 steel and two outer panels of DUCTIBOR 600, which is a ductile steel that provides greater crack resistance than USIBOR 1500. The outer panels are laser welded to the central panel, and the rectangular Tailor welded blank is hot stamped to form battery enclosure tub 320.7. Accordingly, in this example, soft zone 347 may be a DUCTIBOR 600 soft zone, while the remaining portion of flange 330, wall 326, and bottom 322 may be formed from full, high strength USIBOR 1500. Laser weld 328 is depicted in FIG. 10B.

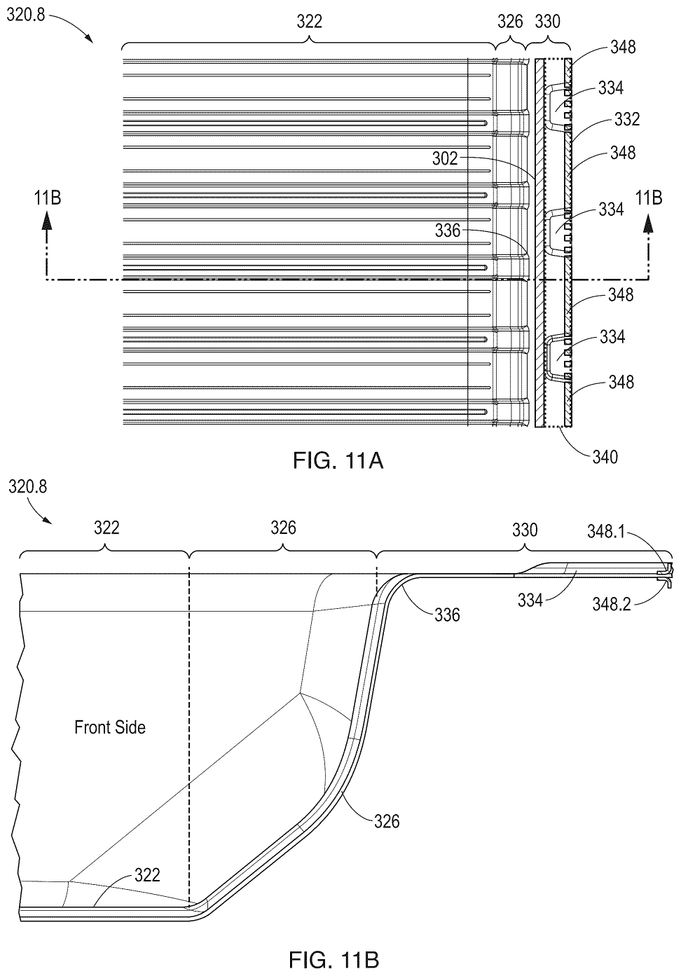

FIGS. 11A, 11B present a top view and a cross sectional view, respectively, of a portion of the right side of battery enclosure tub 320.8, in accordance with embodiments of the present disclosure.

Battery enclosure tub 320.8 includes, inter alia, flange 330, wall 326, and bottom 322 as described above with respect to battery enclosure tub 320. Flange 330 includes outer edge 332, mounting pads 334, inner rim 336, and crack mitigation region 340 formed between outer edge 332 and inner rim 336. Sealing material 302 may be disposed on the upper surface of flange 330 between inner rim 336 and crack mitigation region 340. Wall 326 extends from inner rim 336, and includes an upper portion joined to inner rim 336, and a lower portion. Bottom 322 is joined to the lower portion of wall 326, and is configured to support a battery pack.

Crack mitigation region 340 may include curved flanges 348 that are formed in outer edge 332 to stop, mitigate, or redirect cracks that would otherwise propagate from outer edge 332 of flange 330 into the sealed compartment of battery enclosure 200 by initiating bending at outer edge 332 rather than cracking. In certain embodiments, curved flanges 348 may be formed between pairs of mounting pads 334 (solid line). In other embodiments, curved flanges 348 may be formed along the entire outer edge 332 (solid and dotted lines). Curved flanges 348 may be formed in crack mitigation region 340 during the stamping process, during a post-stamping edge-rolling process, etc.

In certain embodiments, curved flanges 348 include curved flanges 348.1 that extend above the upper surface of flange 330. In other embodiments, curved flanges 348 include curved flanges 348.2 that extend below the lower surface of flange 330. In further embodiments, curved flanges 348 include a combination of curved flanges 348.1 between certain pairs of mounting pads 334, and curved flanges 348.2 between other pairs of mounting pads 334.

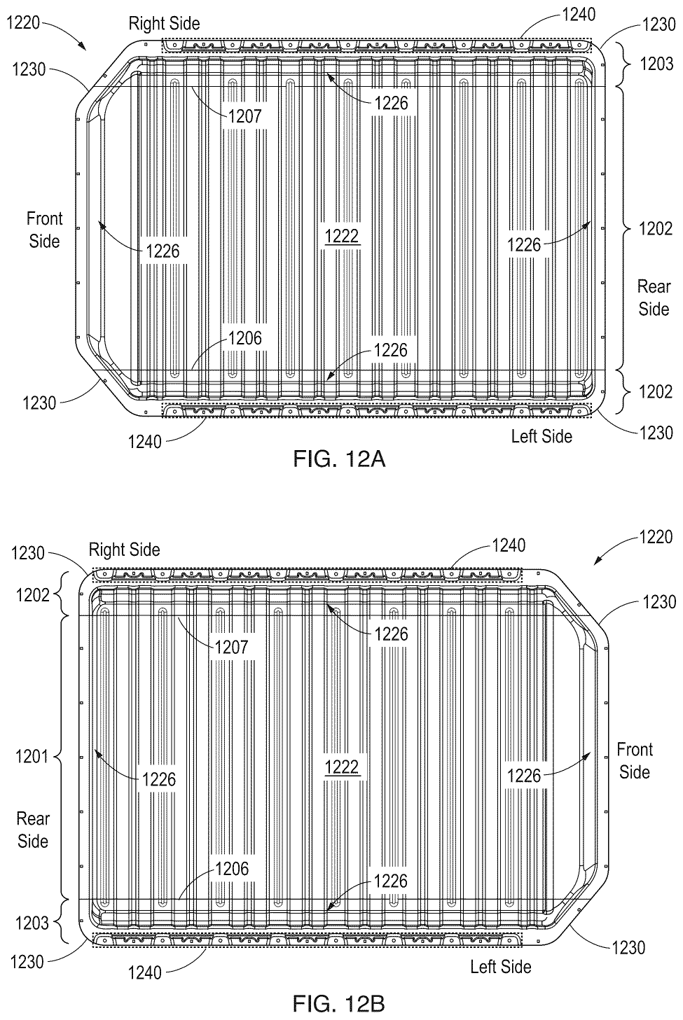

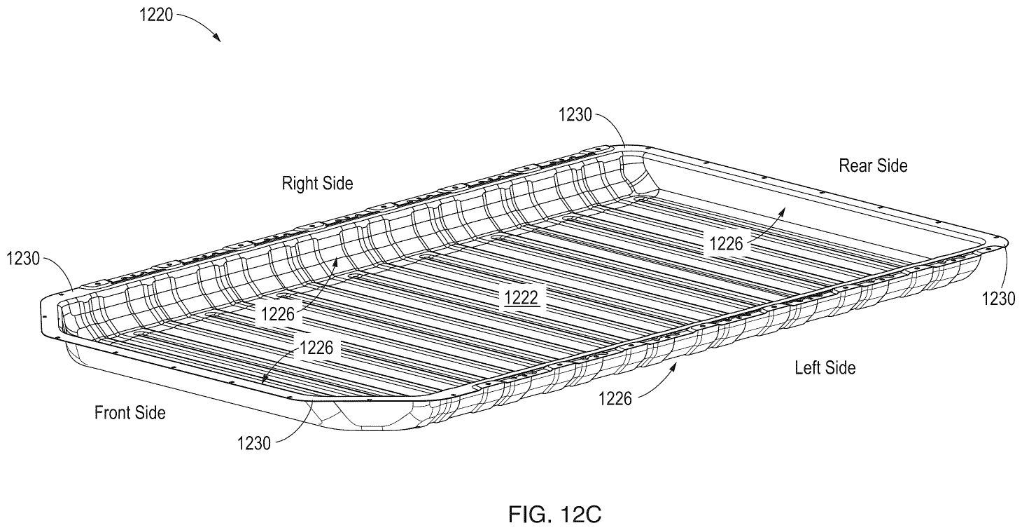

FIGS. 12A, 12B, 12C present a top view, a bottom view, and a perspective view, respectively, of battery enclosure tub 1220, in accordance with embodiments of the present disclosure.

Battery enclosure tub 1220 includes, inter alia, flange 1230, wall 1226, and bottom 1222 as described above with respect to flange 330, wall 326, and bottom 322, respectively. Flange 1230 includes a left side with crack mitigation region 1240, and a right side with crack mitigation region 1240, as described above with respect to crack mitigation region 340. In certain embodiments, one (or more) of the features depicted within FIGS. 4A to 11B may be incorporated within crack mitigation regions 1240.

Battery enclosure tub 1220 may be formed from a Tailor welded blank that includes central panel 1201, left outer panel 1202 laser welded to central panel 1201, and right outer panel 1203 laser welded to central panel 1201. Laser weld 1206 joins central panel 1201 and left outer panel 1202, while laser weld 1207 joins central panel 1201 to right outer panel 1203.

Generally, the thickness of left outer panel 1202 and the thickness of right outer panel 1203 are greater than the thickness of central panel 1201, such as 50% greater, 75% greater, etc. In certain embodiments, central panel 1201 may be a USIBOR 1500 sheet having a thickness between 0.7 mm and 1.0 mm, left outer panel 1202 may be a USIBOR 1500 sheet having a thickness between 1.0 mm and 1.5 mm, and right outer panel 1203 may be a USIBOR 1500 sheet having a thickness between 1.0 mm and 1.5 mm.

FIGS. 12D, 12E present a top view and a bottom view, respectively, of a portion of the right side of battery enclosure tub 1220, in accordance with embodiments of the present disclosure.

Flange 1230 includes outer edge 1232, mounting pads 1234, inner rim 1236, and crack mitigation region 1240 formed between outer edge 1232 and inner rim 1236. Wall 1226 extends from inner rim 1236, and includes an upper portion joined to inner rim 1236, and a lower portion. Bottom 1222 is joined to the lower portion of wall 1226, and is configured to support a battery pack. Flange 1230 also includes openings 1213 for fasteners 212, and openings 1215 for fasteners 214.

Crack mitigation region 1240 may include beads 1249 that are formed between mounting pads 1234 to stop, mitigate, or redirect cracks that would otherwise propagate from outer edge 1232 of flange 1230 into the sealed compartment of battery enclosure 200. In certain embodiments, two beads 1249 may be formed between each pair of adjacent mounting pads 1234. Beads 1249 may be formed in crack mitigation region 1240 during the stamping process described above.

In certain embodiments, beads 1249 include a combination of beads 1249.1 that extend above the upper surface of flange 1230, and beads 1249.2 that extend below the lower surface of flange 1230. Beads 1249.1 may be formed in a curvilinear shape (as depicted), while beads 1249.2 may be formed in a straight line. Beads 1249.1 may be stamped such that the height above the upper surface of flange 1230 is less than or equal to 75% of the height of mounting pads 1234. Similarly, beads 1249.2 may be stamped such that the depth below the lower surface of flange 1230 is equal to or less than the depth permitted by the formability of the stamping process.

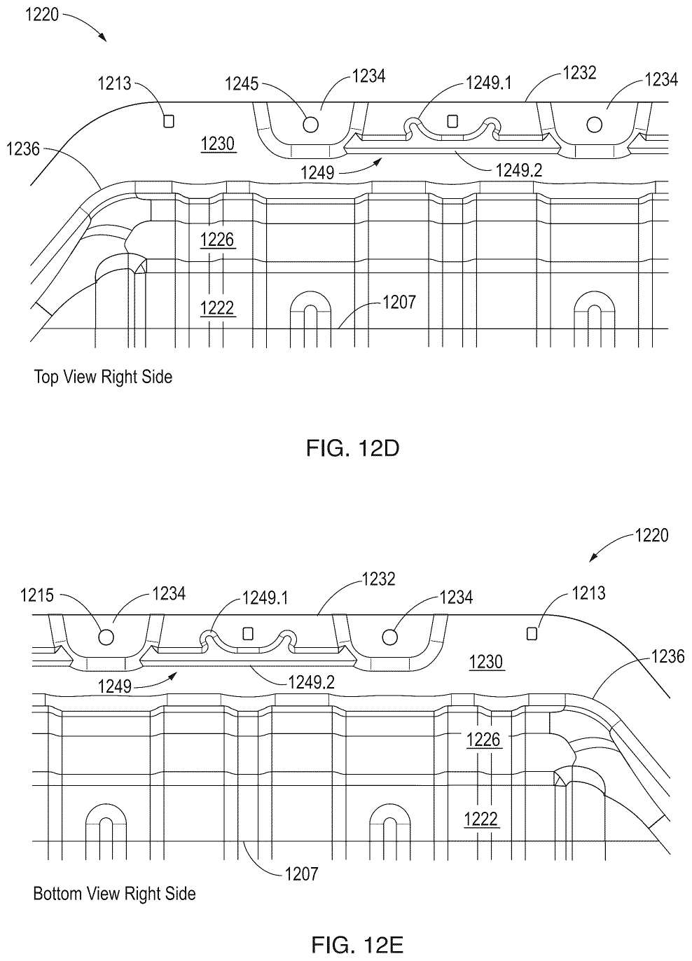

FIG. 13 presents a perspective view of battery enclosure tub 1320, in accordance with embodiments of the present disclosure.

Battery enclosure tub 1320 includes, inter alia, the same components as battery enclosure tub 1220. However, battery enclosure tub 1320 may be formed from a Tailor welded blank that includes central panel 1301, left outer panel 1302, right outer panel 1303, front panel 1304, and rear panel 1305. Central panel 1301 is laser welded to all of the other panels, i.e., left outer panel 1302, right outer panel 1303, front panel 1304, and rear panel 1305. Additionally, left outer panel 1302 is laser welded to front panel 1304 and rear panel 1305, and right outer panel 1303 is laser welded to front panel 1304 and rear panel 1305.

Laser weld 1306 joins central panel 1301 and left outer panel 1302, laser weld 1307 joins central panel 1301 to right outer panel 1303, laser weld 1308 joins front panel 1304 to central panel 1201, left outer panel 1202 and right outer panel 1303, and laser weld 1309 joins rear panel 1305 to central panel 1201, left outer panel 1202 and right outer panel 1303.

Generally, the thickness of left outer panel 1302 and the thickness of right outer panel 1303 are greater than the thickness of central panel 1301, such as 50% greater, 75% greater, etc., and may be greater than the thickness of front panel 1304 and rear panel 1305. In certain embodiments, central panel 1301 may be a USIBOR 1500 (or DUCTIBOR 600) sheet having a thickness between 0.7 mm and 1.0 mm, left outer panel 1302 may be a USIBOR 1500 sheet having a thickness between 1.0 mm and 1.5 mm, right outer panel 1303 may be a USIBOR 1500 sheet having a thickness between 1.0 mm and 1.5 mm, front panel 1304 may be a USIBOR 1500 sheet having a thickness between 1.0 mm and 1.2 mm, and rear panel 1305 may be a USIBOR 1500 sheet having a thickness between 1.0 mm and 1.2 mm.

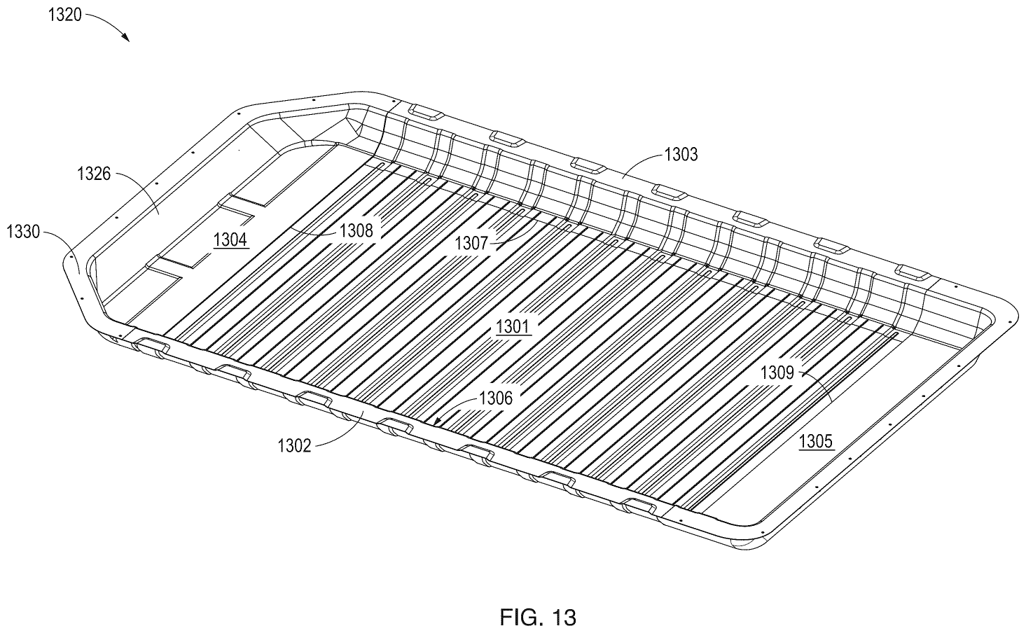

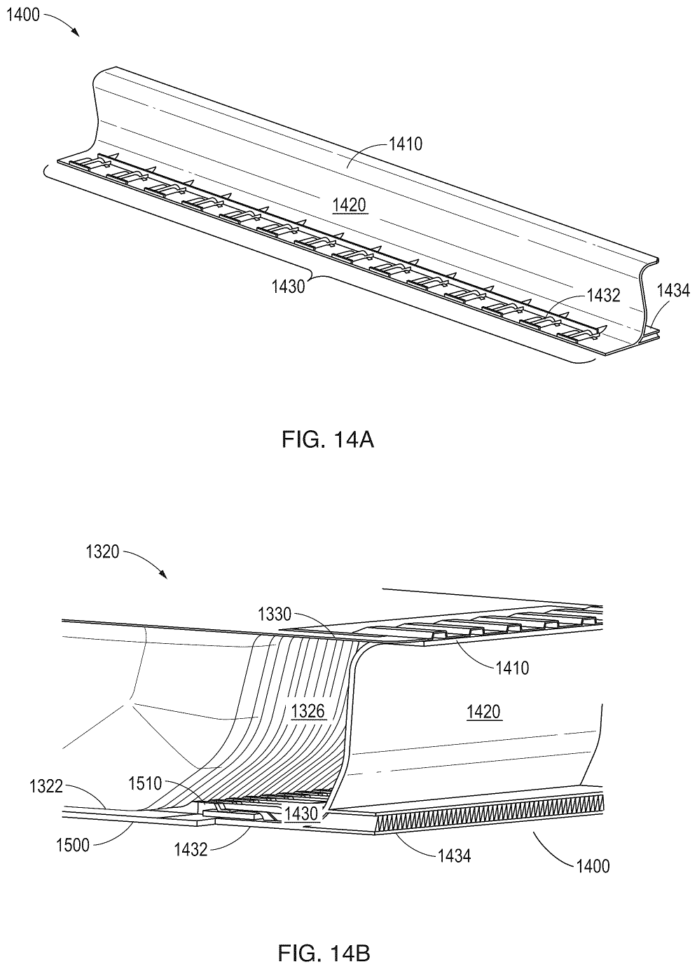

FIG. 14A presents a perspective view of composite cover 1400, in accordance with embodiments of the present disclosure.

Composite cover 1400 includes, inter alia, upper surface 1410, support wall 1420, and base 1430. Base 1430 includes fasteners 1432, such as clips, etc., and a stiffness region 1434 that extends from the lower portion of support wall 1420 to the outer edge of upper surface 1410.

In certain embodiments, composite cover 1400 is injection or compression molded from glass-filled polymer. Generally, composite cover 1400 forms one portion of a box section to take the load during a side pole impact, and to create torsional stability for battery enclosure 200.

FIG. 14B presents a perspective view of a portion of battery enclosure tub 1320, plate 1500, and composite cover 1400, in accordance with embodiments of the present disclosure.

Plate 1500 is attached to bottom 1322 of battery enclosure tub 1320, and includes a first side with fasteners 1510, and a second side with fasteners.

A first composite cover 1400 is attached to fasteners 1510 of plate 1500 using fasteners 1432, and upper surface 1410 abuts a portion of the first side of flange 1330. The first composite cover 1400, the first side of flange 1330, and a portion of wall 1326 form a first box section. Although not depicted, a second composite cover may be attached to the fasteners on the second side of plate 1500, and the upper surface of the second composite cover may abut a portion of the second side of flange 1330. The second composite cover, the second side of flange 1330, and another portion of wall 1326 form a second box section.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A battery enclosure apparatus, comprising:
a flange including an outer edge, an inner rim defining an opening, and crack mitigation regions formed between the outer edge and the inner rim;
a wall extending from the inner rim of the flange, the wall including a first portion and a second portion, the first portion joined to the inner rim of the flange; and
a bottom, joined to the second portion of the wall, the bottom configured to support a battery pack.

2. The battery enclosure apparatus of claim 1, wherein:
the flange has at least a first side and a second side,
a first crack mitigation region is formed in the first side of the flange, and
a second crack mitigation region is formed in the second side of the flange.

3. The battery enclosure apparatus of claim 1, wherein the flange, the wall, and the bottom are formed from a metal sheet by a stamping process.

4. The battery enclosure apparatus of claim 3, wherein:
the metal sheet has a number of panels;
each crack mitigation region is formed in a first panel having a first thickness; and
at least a portion of the bottom is formed in a second panel having a second thickness that is less than the first thickness.

5. The battery enclosure apparatus of claim 4, wherein the metal sheet is a tailor welded blank or a portion of a tailor welded coil.

6. The battery enclosure apparatus of claim 2, wherein an upper surface of the flange is configured to accept a sealing material between the crack mitigation regions and the inner rim.

7. The battery enclosure apparatus of claim 2, further comprising:
a plate, attached to the bottom, the plate including a first side having a plurality of fasteners, and a second side having a plurality of fasteners;
a first composite cover, attached to the first side of the plate, the first composite cover including a base having plurality of fasteners, a support wall, and an upper surface abutting a portion of a lower surface of the first side of the flange; and
a second composite cover, attached to the second side of the plate, the second composite cover including a base having a plurality of fasteners, a support wall, and an upper surface abutting a portion of a lower surface of the second side of the flange,
wherein the first composite cover, the first side of the flange, and a portion of the support wall form a first box section, and
wherein the second composite cover, the second side of the flange, and a portion of the support wall form a second box section.

8. A battery enclosure apparatus, comprising:
a flange including an outer edge, an inner rim defining an opening, a first side including a first crack mitigation region formed between the outer edge and the inner rim, and a second side including a second crack mitigation region formed between the outer edge and the inner rim;
a wall extending from the inner rim of the flange, the wall including a first portion and a second portion, the first portion joined to the inner rim of the flange; and
a bottom, joined to the second portion of the wall, the bottom configured to support a battery pack,
wherein the flange, the wall, and the bottom are formed from a metal sheet by a stamping process, and
wherein each crack mitigation region includes mounting pads, formed by the stamping process, that extend above an upper surface of the flange.

9. The battery enclosure apparatus of claim 8, wherein:
each crack mitigation region includes beads that are formed by the stamping process; and
the beads extend above the upper surface of the flange, the beads extend below a lower surface of the flange, or certain beads extend above the upper surface of the flange and other beads extend below the lower surface of the flange.

10. The battery enclosure apparatus of claim 9, wherein at least one bead is formed between each pair of adjacent mounting pads.

11. The battery enclosure apparatus of claim 8, wherein:
each crack mitigation region includes openings that are formed by the stamping process; and
at least one opening is disposed between each pair of adjacent mounting pads.

12. The battery enclosure apparatus of claim 8, wherein
each crack mitigation region includes soft zones; and
at least one soft zone is disposed between each pair of adjacent mounting pads.

13. The battery enclosure apparatus of claim 8, wherein each crack mitigation region is a soft zone.

14. The battery enclosure apparatus of claim 8, wherein each crack mitigation region has a first ductility that is greater than a second ductility of a remaining region of the flange between each crack mitigation region and the inner rim.

15. The battery enclosure apparatus of claim 8, wherein each crack mitigation region has a curved flange formed from the outer edge of the flange.

16. A battery enclosure, comprising:
a battery enclosure tub formed from a metal sheet by a stamping process, the battery enclosure tub comprising:
a flange including an outer edge, an inner rim defining an opening, and crack mitigation regions formed between the outer edge and the inner rim;
a wall extending from the inner rim of the flange, the wall including a first portion and a second portion, the first portion joined to the inner rim of the flange; and
a bottom, joined to the second portion of the wall, the bottom configured to support a battery pack,
a battery enclosure cover attached to the battery enclosure; and
sealing material disposed between the battery enclosure tub and the battery enclosure cover.

17. The battery enclosure of claim 16, wherein:
the metal sheet is a tailor welded blank;
each crack mitigation region is formed in a first region of the metal sheet, the first region having a first thickness; and
at least a portion of the bottom is formed in a second region of the metal sheet, the second region having a second thickness that is less than the first thickness.

18. The battery enclosure of claim 17, wherein:
each crack mitigation region includes mounting pads, formed by the stamping process, that extend above an upper surface of the flange;
each crack mitigation region includes beads that are formed by the stamping process; and
at least one bead is formed between each pair of adjacent mounting pads.

19. The battery enclosure of claim 17, wherein:
each crack mitigation region includes mounting pads, formed by the stamping process, that extend above an upper surface of the flange;
each crack mitigation region includes openings that are formed by the stamping process; and
at least one opening is disposed between each pair of adjacent mounting pads.

20. The battery enclosure of claim 17, wherein:
each crack mitigation region includes mounting pads, formed by the stamping process, that extend above an upper surface of the flange;
each crack mitigation region includes soft zones; and
at least one soft zone is disposed between each pair of adjacent mounting pads.
